(19) United States
(12) Patent Application Publication
(10) Pub. No.: US 2024/0123538 A1
(43) Pub. Date: Apr. 18, 2024

(54) PISTOL GRIP FOR A PROCESSING TORCH

(71) Applicant: ESAB AB, Gothenburg (SE)

(72) Inventors: Marc Hartel, Reiskirchen (DE); Artem Kerber, Butzbach (DE)

(21) Appl. No.: 17/964,154

(22) Filed: Oct. 12, 2022

(51) Int. Cl. B23K 9/32

(52) U.S. Cl. CPC B23K 9/32

(57) ABSTRACT

A pistol grip for a processing torch is disclosed. The pistol grip includes a main body having a proximal end and a distal end, a pistol trigger having a trigger extension, and a locking mechanism movably coupled to the main body adjacent the proximal end of the main body. The proximal end may be configured to engage a portion of the processing torch. The pistol trigger may be pivotably coupled to the main body. The locking mechanism may be movable between an unlocked position and a locked position where the locking mechanism locks the main body in a fixed position with respect to the processing torch.

### FIELD OF INVENTION

The present invention relates to the field of processing torches, and, in particular, a pistol grip for a processing torch.

### BACKGROUND

Removable pistol grips for processing torches (e.g., a welding torch or a cutting torch) provide an ergonomic grip for a user. The removable pistol grip typically has some fixing mechanism requiring a tool to couple the pistol grip to a torch. Alternatively, the fixing mechanism may include a release mechanism that is exposed during use of the torch. The exposed release mechanism may be inadvertently contacted and moved to an unlocked position during use of the torch. Consequently, the pistol grip may inadvertently disengage from the torch thereby damaging the torch and/or workpiece.

### SUMMARY

The present invention relates to techniques for attaching and locking a pistol grip to a processing torch. In accordance with at least one embodiment of the present invention, the pistol grip includes a main body having a proximal end and a distal end, a pistol trigger having a trigger extension, and a locking mechanism movably coupled to the main body adjacent to the proximal end of the main body. The proximal end may be configured to engage a portion of the processing torch. The pistol trigger may be pivotably coupled to the main body. The locking mechanism may be movable between an unlocked position and a locked position where the locking mechanism locks the main body in a fixed position with respect to the processing torch. The locking mechanism may be prevented from moving from the locked position to the unlocked position when the pistol grip is gripped by a user's hand.

In accordance with another embodiment, the techniques described herein relate to a torch including: a torch head; a body portion; and a pistol grip removably couplable to the body portion. The pistol grip includes a distal end; a proximal end configured to engage the body portion; and a locking mechanism operable between a locked position and an unlocked positioned. The locking mechanism may be prevented from moving to an unlocked position when the pistol grip is gripped by a user's hand.

In accordance with yet another embodiment, the techniques described herein relate to a method including inserting a protrusion extending from a torch into a groove of a pistol grip; moving the pistol grip in a first direction until a locking mechanism disposed on a proximal end of the pistol grip engages the torch; and biasing the locking mechanism into a locked position to lock the pistol grip to the torch.

### BRIEF DESCRIPTION OF THE DRAWINGS

To complete the description and in order to provide for a better understanding of the present invention, a set of drawings is provided. The drawings form an integral part of the description and illustrate an embodiment of the present invention, which should not be interpreted as restricting the scope of the invention, but just as an example of how the invention can be carried out. The drawings comprise the following figures:

FIG. 1 is side view of view of a torch assembly, according to an exemplary embodiment of the present invention.

FIG. 2A is a partially exploded view of the torch assembly of FIG. 1 with a pistol grip locking mechanism according to a first embodiment.

FIG. 2B is a cross-sectional view of the torch assembly of FIG. 1 where the pistol grip is secured to the torch via the first embodiment of the pistol grip locking mechanism.

FIG. 2C is a perspective top view of the pistol grip of FIGS. 2A and 2B.

FIG. 3A is a cross-sectional view of a torch assembly equipped with a pistol grip having a locking mechanism according to a second embodiment.

FIG. 3B is a perspective rear view of the torch assembly of FIG. 3A.

FIG. 4A is a cross-sectional view of a torch assembly equipped with a pistol grip having a locking mechanism according to a third embodiment.

FIG. 4B is a partially exploded view of the torch assembly of FIG. 4A.

FIG. 4C is a partially exploded view of the locking mechanism of FIG. 4A.

### DETAILED DESCRIPTION

The following description is not to be taken in a limiting sense but is given solely for the purpose of describing the broad principles of the invention. Embodiments of the invention will be described by way of example, with reference to the above-mentioned drawings showing elements and results according to the present invention.

Generally, techniques for attaching and locking a pistol grip to a processing torch include a pistol grip configured to attach to a processing torch via a coupling mechanism and movable locking mechanism disposed at a proximal end of the pistol grip. The locking mechanism locks the pistol grip to the torch. The coupling mechanism includes grooves configured to receive protrusions extending laterally from opposite sides of the torch.

The locking mechanism includes a locking tab, or actuator, and a biasing member configured to bias the locking tab into engagement with the torch. When the locking mechanism is in a locked position or state, the locking tab engages the torch. The pistol grip remains coupled to the torch until the locking mechanism is moved or repositioned to an unlocked position or state. The claimed terminology is used to describe a locking mechanism positioned in such a way that when the torch is held in a user's hand (i.e., the user's hand is disposed about the pistol grip), the locking mechanism cannot move to the unlocked position or state. That is, the locking mechanism is disposed at the proximal end of the pistol grip and configured remain in the locked position when the pistol grip is gripped by a user's hand. Said another way, the locking mechanism is positioned in the locked position and prevented from moving or repositioning from the locked position to an unlocked position when the pistol grip is gripped by a user's hand.

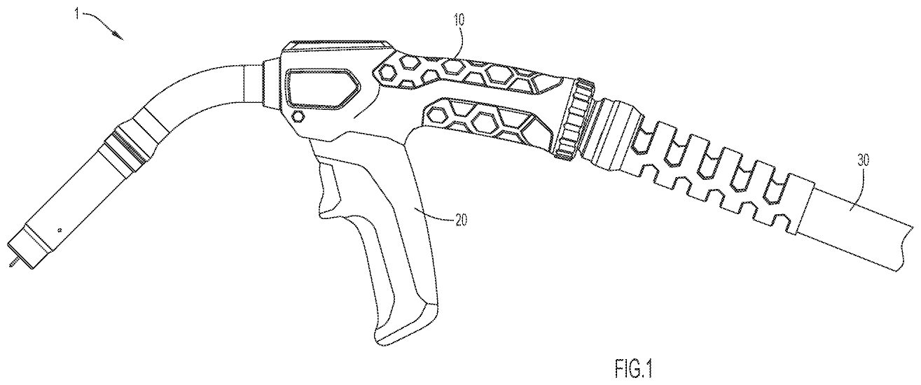

Now referring to FIG. 1, an example embodiment of a torch assembly 1 comprising a torch 10, a pistol grip 20, and a cable 30 is illustrated. The pistol grip 20 is coupled to a bottom portion of the torch 10 and extends downward. The pistol grip 20 provides an ergonomic grip for a user to hold and control the torch 10. The cable 30 couples the torch 10 to a power source and/or wire feeder (not shown). In the depicted embodiment, the torch assembly 1 is configured for performing a metal inert gas (MIG) welding operation and/or metal active gas (MAG) welding operation. In some implementations, the torch may be configured for performing other welding or cutting operations. That is, the techniques described herein may be applied to both welding torches and cutting torches.

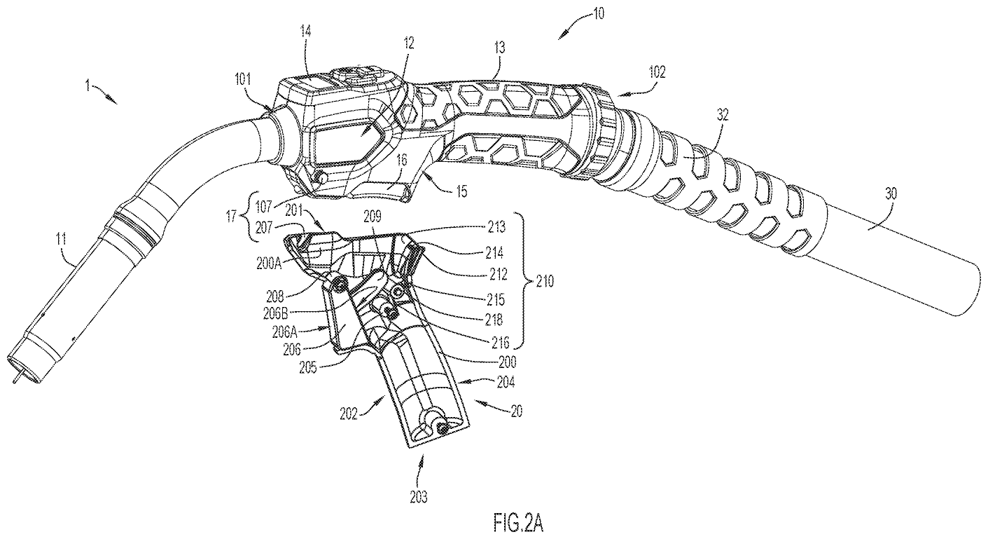

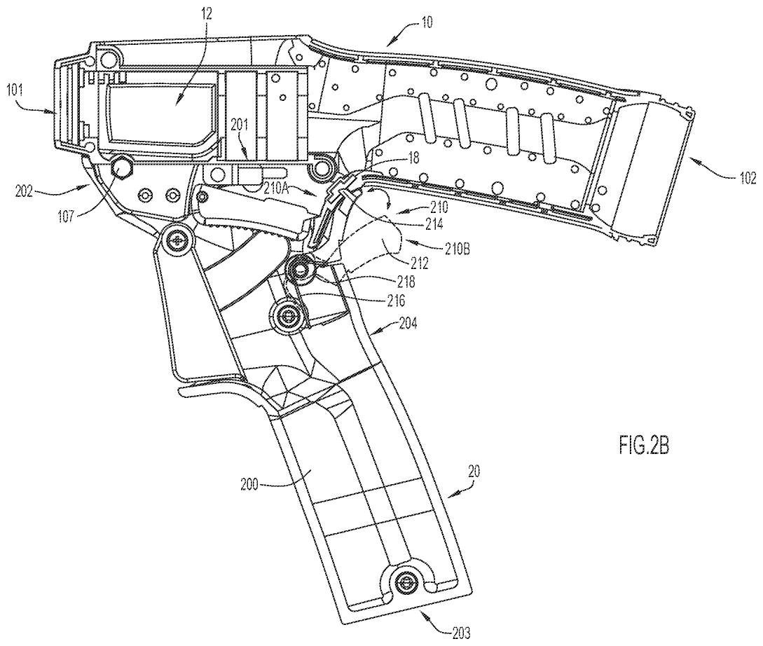

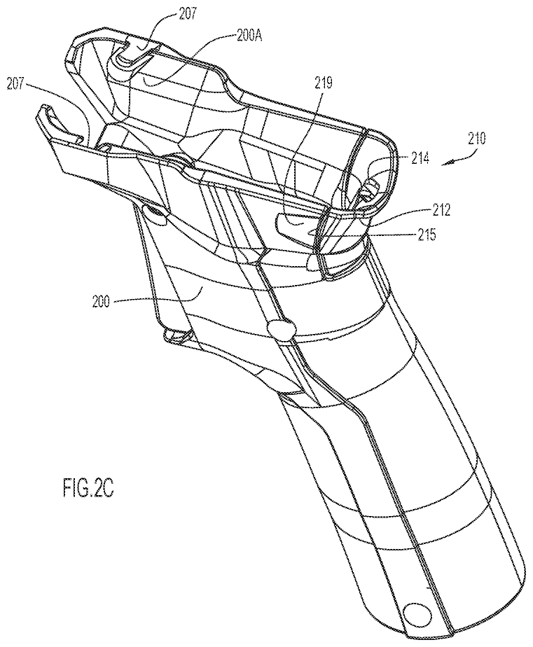

Now referring to FIG. 2A, the torch 10 and the pistol grip 20 according to an exemplary embodiment are described. The torch 10 includes a head 11, a body portion 12, and a strain relief 32 configured to support the cable 30. The head 11 extends from a first (front) end 101 of the body 12, while the strain relief 32 and cable 30 extend from a second (rear) end 102 of the body 12, opposite the first end 101. The body 12 includes a handle 13, a control module portion 14, a trigger housing portion 15 extending downward, opposite the control module portion 14, and a locking recess, groove, or slot 18 (see FIG. 2B). The trigger housing portion 15 includes a pivotably mounted trigger 16 and coupling protrusions 107 extending laterally from two opposing sides of the torch 10. That is, a second coupling protrusion (not shown) extends laterally from the side of the body 12 opposite the illustrated coupling protrusion 107. The torch 10 is configured to be operated with or without the pistol grip 20. That is, a user may grip the handle 13 and operate the torch 10 without the pistol grip 20. Alternatively, the user may operate the torch 10 by attaching the pistol grip 20 to the body 12 of the torch 10 and gripping the pistol grip.

Regardless of whether the pistol grip 20 is attached, the torch 10 can control various operating parameters of a welding process. For example, the control module portion 14 may include an interface for adjusting one or more welding parameters, such as arc current, arc voltage, wire feed speed, etc. That is, the interface may send one or more control signals through the cable 30 to one or more system components (e.g., a power supply and/or a wire feeder) to adjust welding or cutting parameters. The trigger 16 may transmit one or more signals to the system component(s) (not shown) to initiate, maintain, deactivate, and/or otherwise control one or more parameters of the welding process. For example, actuating or otherwise depressing the trigger 16 may transmit a control signal instructing the system component(s) to initiate an arc and/or feed a weld wire, which is maintained until the trigger 16 is actuated or depressed a second time to deactivate the arc and/or feeding of the weld wire. Alternatively, depressing or actuating the trigger 16 may initiate and maintain a welding operation until the trigger 16 is released. That is, the arc may be initiated and maintained, and/or wire may be continually fed through the torch head 11 while the trigger 16 is depressed. Releasing the trigger 16 may deactivate the arc and/or feeding of the wire. In some implementation, the trigger 16 may throttle the amount of power of the arc and/or wire feed speed based on how far the trigger 16 is depressed. For example, the trigger 16 may be disposed in one or more positions between a fully depressed position (corresponding to a maximum power and/or wire feed speed) and a fully released position (corresponding to a minimum power and/or wire feed speed, or a deactivated state). The one or more positions may each correspond to one or more power output levels and/or wire feed speeds. Regardless of the trigger 16 configuration, actuation of the trigger 16 ultimately initiates, maintains, deactivates, and/or otherwise controls one or more parameters of the welding process.

Still referring to FIG. 2A, a partially exploded view of the torch assembly 1 with a cross-sectional view of the pistol grip 20 is depicted. The pistol grip 20 includes a main body 200 and a locking mechanism 210 for locking the main body 200 to the torch 10. The main body 200 includes a proximal end 201, a distal end 203 opposite the proximal end 201, a front portion 202 and a rear portion 204 opposite the front portion 202. The main body 200 is defined by a contoured sidewall shaped to be gripped by a user's hand. The proximal end 201 of the contoured sidewall and a portion of the locking mechanism 210 define an opening shaped to conform to at least a portion of the body 12 of the torch 10 near the torch trigger 16. The main body 200 further includes coupling grooves 207 extending along an inner surface 200A of the contoured sidewall for coupling the pistol grip 20 to the torch 10.

The pistol grip 20 further incudes a pistol trigger 206 pivotably coupled to the main body 200 via a trigger pivot 208. The pistol trigger 206 includes an exterior face 206A, an interior face 206B, and a trigger extension 209 extending from the interior face 206B. The trigger extension 209 is configured to actuate the torch trigger 16 when the pistol grip 20 is coupled to the torch 10. That is, when the pistol grip 20 is coupled to the torch 10, depressing the pistol trigger 206 causes the trigger extension 209 to engage and actuate the torch trigger 16 by a desired amount. Said another way, actuating the pistol trigger 206 by a desired amount actuates the torch trigger 16 by a corresponding amount when the pistol grip 20 is attached to the torch 10.

The pistol grip 20 attaches to the torch 10 via a coupling mechanism 17 and the locking mechanism 210 disposed adjacent to the proximal end 201. In the depicted embodiment, the coupling mechanism 17 is a pin and groove arrangement comprising the coupling protrusions 107 and the coupling groves 207. The coupling grooves 207 are configured to receive the coupling protrusions 107 extending from the torch body 12. In the depicted embodiment, the coupling grooves 207 extend along opposing sides of the inner surface 200A of the pistol grip 20 from the proximal end 201 toward the distal end 203 and the front portion 202 of the main body 200 (see FIG. 2C). To couple the torch 10 to the pistol grip 20, the protrusions 107 are inserted into the grooves 207. Once the coupling grooves 207 receive the coupling protrusions 107, the front portion 202 of the pistol grip 20 is prevented from translating upward toward the torch 10 and/or rearward toward the cable 30. However, the pistol grip 20 may rotate until the locking mechanism 210 engages the torch 10. In some implementations, the coupling mechanism may be any mechanical fixing device that operably couples the pistol grip 20 to the torch 10.

With reference to FIGS. 2B and 2C, and continued reference to FIG. 2A, the locking mechanism 210 is described. For clarity, the torch head 11, the strain relief 32, and the cable 30 have been omitted in FIGS. 2B and 2C. The locking mechanism 210 is disposed in the proximal end 201 and configured to move between a locked position 210A and an unlocked position 210B. In FIG. 2B, the locking mechanism 210 is illustrated in both the locked position 210A (solid lines) and unlocked position 210B (broken lines). In the unlocked position 210B, the locking mechanism 210 is disposed away from the torch 10, and the main body 200 is free to rotate and/or move forward toward the front end 101 of the torch 10, and/or move downward toward the distal end 203 of the pistol grip 20. In the locked position 210A, the locking mechanism 210 locks the pistol grip 20 to the torch body 12 and prevents the main body 200 from translating, rotating, repositioning, and/or otherwise moving toward the front end 101, the distal end 203, and/or otherwise away from the torch body 12. Consequently, the coupling protrusions 107 cannot be removed from the coupling groove 207 while the locking mechanism 210 is in the locked position 210A. Thus, the coupling mechanism 17 and the locking mechanism 210 cooperate to couple and lock the pistol grip 20 to the torch 10.

The locking mechanism 210 includes a locking tab 212 having an inner surface 213, a locking protrusion 214 extending from the inner surface 213, a biasing member 216 (e.g., a spring or an otherwise resilient plate or strip), and a pivot 218. The locking tab 212 is disposed at the proximal end 201 along the rear portion 204 of the main body 200. The pivot 218 is disposed at a distal portion of the locking tab 212 and pivotably mounts the locking mechanism 210 to an interior of the main body 200.

In the locked position 210A, the locking tab 212 defines a portion of the opening at the proximal end 201. For example, in the depicted embodiment, the opening is defined by the contoured sidewall of the main body 200 and the locking tab 212. The locking tab 212 defines a proximal, rear portion 204 of the opening in the pistol grip 20 and generally follows the contoured shape of the main body 200. That is, the locking tab 212 is shaped to follow the contours of the main body 200 and conform to at least a portion of the torch body 12 such that the locking mechanism 210 can engage the torch 10 with the locking protrusion 214.

The locking mechanism 210 secures the pistol grip 20 to the torch 10 via the locking protrusion 214. For example, the coupling protrusion 107 engages the coupling grooves 207 to couple the pistol grip 20 the torch 10. Meanwhile, when the locking mechanism 210 is in the locked position 210A, the locking protrusion 214 and the slot 18 cooperate (i.e., the locking protrusion 214 is at least partially disposed within the slot 18) to prevent the locking tab 212 and thus the main body 200 from translating, rotating, repositioning, and/or otherwise moving away from the torch 10.

The biasing member 216 biases the locking mechanism 210 toward the locked position 210A. The biasing member 216 is coupled to and extends from the pivot 218 and presses against the bearing member 205 of the main body 200, thereby generating a spring load or biasing force. In FIG. 2B, the biasing member 216 is shown with the locking mechanism 210 in a both the locked position 210A and unlocked position 210B (where the biasing member 216 is compressed or resiliently loaded). The biasing member 216 transmits the spring load to the locking tab 212 via the pivot 218. That is, the spring load in the biasing member is applied to the pivot 218 of the locking tab 212 to generate a torque. The torque biases the locking tab 212 toward the locked position 210A. Accordingly, the biasing member 216 biases the locking mechanism 210 into the locked position 210A and the locking tab 212 into engagement with the torch 10 (i.e., such that the locking protrusion 214 is at least partially disposed within the slot 18).

The locking mechanism 210 and coupling mechanism 17 cooperate to couple and lock the pistol grip 20 to the torch 10. To couple the pistol grip 20 to the torch 10, the coupling protrusions 107 of the torch 10 slide into the coupling grooves 207 of the pistol grip 20 until the main body 200 receives the torch body 12, and the locking mechanism 210 snaps onto and engages the torch body 12. The biasing member 216 biases the locking mechanism 210 toward the locked position 210A which causes the locking tab 212 to push against the torch body 12 and thereby engage the slot 18 with the locking protrusion 214. The biasing member 216 may further cause the locking tab 212 to pull main body 200 toward the rear end 102 of the torch 10 until the coupling protrusions 107 engage an end wall of the coupling grooves 207. Additionally, the locking protrusion 214 is disposed within the slot 18 in the torch body 12 thereby preventing main body 200 from translating, rotating, repositioning, and/or otherwise moving away from the torch 10. Consequently, the locking mechanism 210 engages torch body 12 and prevents the coupling protrusions 107 from disengaging the coupling grooves 207.

When the pistol grip 20 is coupled and locked to the torch 10, a user may grip the main body 200 to operate the torch assembly 1. For example, the user may grip the main body 200 and actuate the pistol trigger 206 to actuate the torch trigger 16 by a corresponding amount. That is, the trigger extension 209 moves with the pistol trigger 206 to engage and actuate the torch trigger 16 in a corresponding manner. The trigger extension 209 may be arranged closer or farther from the trigger pivot 208 to thereby adjust a ratio between actuation amount of the pistol trigger 206 to actuation amount of torch trigger 16. In the depicted embodiment, the trigger extension 209 is disposed at about a middle of the pistol trigger 206, resulting a 1 to 1 ratio of pistol trigger 206 to torch trigger 16 actuation amounts.

Still referring to FIGS. 2A-2C, when operating the torch assembly 1, the locking mechanism 210 is positioned and configured to support at least a portion of the user's hand. For example, the locking tab 212 is positioned at the proximal end 201 along the rear portion 204 of the main body and is configured to receive and/or engage at least a portion of the user's hand. The locking tab 212 transmits at least a portion of a force applied by the user's grip to the torch 10 and/or main body 200. Consequently, the force transmitted by the locking tab 212 prevents the locking mechanism 210 from moving to the unlocked position 210B. Said another way, the locking mechanism 210 is configured such that by operating the torch assembly 1, the user's hand further biases the locking tab 212 toward the locked position 210A, thereby locking the main body 200 in a fixed position with respect to the torch 10. Moreover, the position and configuration of the locking mechanism 210 prevents inadvertent release during normal operation of the torch assembly 1 (discussed further below).

To remove the pistol grip 20 from the torch 10, the locking mechanism 210 moves from the locked position 210A to the unlocked position 210B, and thus, allows the main body 200 to rotate and/or otherwise move away from the torch 10. In the depicted embodiment, the locking mechanism 210 is unlocked by rotating the locking tab 212 from the locked position 210A to the unlocked position 210B. That is, the locking tab 212 is rotated away from the torch body 12 until the locking protrusion 214 disengages the locking slot 18 in the torch body 12. To rotate the locking tab 212, a release force is applied to the locking tab 212 to overcome the biasing force from the biasing member 216. Consequently, the locking mechanism 210 moves toward the unlocked position 210B.

To assist a user in unlocking the locking mechanism 210, the locking tab 212 may include lateral flanges 215 for receiving the release force. Additionally, or alternatively, the main body 200 of the grip 20 may include lateral grooves, cutouts, or depressions 219 for exposing the lateral flanges 215 of the locking tab 212 in the locked position 210A. Thus, a user can apply a release force to the flanges 215 to move the locking mechanism 210 into the unlocked position 210B (e.g., the user may grip the flanges 215 with of their fingers and pull the locking tab 212 rearward causing the locking tab 212 to rotate about the pivot 218).

With the locking mechanism 210 in the unlocked position 210B, the pistol grip 20 can translate, rotate, and/or otherwise move away from the torch 10. In the unlocked position 210B, the coupling protrusions 107 and coupling grooves 207 are the only coupling means between the torch 10 and pistol grip 20. When the locking protrusion 214 disengages the locking slot 18, the coupling protrusion 107 are free to slide out of the coupling grooves 207 to disengage the main body 200 of the pistol grip 20 from the torch 10. Consequently, the pistol grip 20 can translate, rotate, and/or otherwise move away from the torch 10 such that the coupling protrusions 107 exit the coupling grooves 207.

As the main body 200 is being translated away from the torch 10, the locking mechanism 210 may remain in the unlocked position 210B until the main body 200 moves away from the torch 10 by a sufficient distance in order to prevent the locking protrusion 214 from reengaging the locking groove or slot 18. The locking tab 212 may return to the locked position 210A once the main body 200 has moved away from the torch 10 by the sufficient distance. In another approach, a user can apply a release force to the locking tab 212 to overcome the biasing force and place the locking mechanism 210 in the unlocked position 210B as the main body 200 moves away from the torch 10. With the locking tab 212 in the unlocked position 210B, the user can translate, rotate, or otherwise move the main body 200 the sufficient distance from the torch 10 to prevent reengagement of the locking protrusion 214 with the locking slot 18. Once the main body 200 has been translated the sufficient distance, the user may then release the locking tab 212 such that the locking mechanism 210 returns to the locked position 210A (without the locking tab 212 engaging the torch body 12). The user may further separate the main body 200 from the torch 10 until the coupling protrusions 107 exit the coupling grooves 207. Accordingly, the pistol grip 20 may be uncoupled and removed from the torch 10.

As noted above, the position and configuration of the locking mechanism 210 prevents its inadvertent unlocking. By disposing the locking tab 212 of the locking mechanism 210 at the proximal end 201 and along the rear portion 204 of the main body 200, the user's hand covers at least a portion of the locking tab 212 during operation of the torch assembly 1 (i.e., when gripping the main body 200 of the pistol grip 20). Thus, a release force cannot be applied to the locking tab 212, purposefully or inadvertently, while the user grips the main body 200. Consequently, the configuration of the locking mechanism 210 prevents the locking tab 212 from moving to the unlocked position 210B during normal operation of the torch assembly 1. That is, the locking mechanism 210 is positioned or otherwise configured to be inaccessible when the user operates the torch assembly 1 during a welding operation

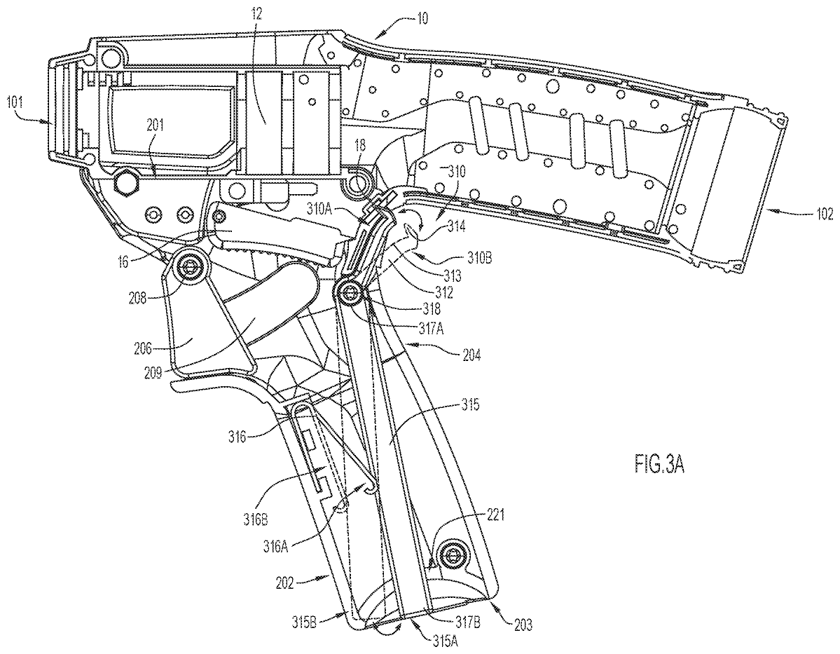

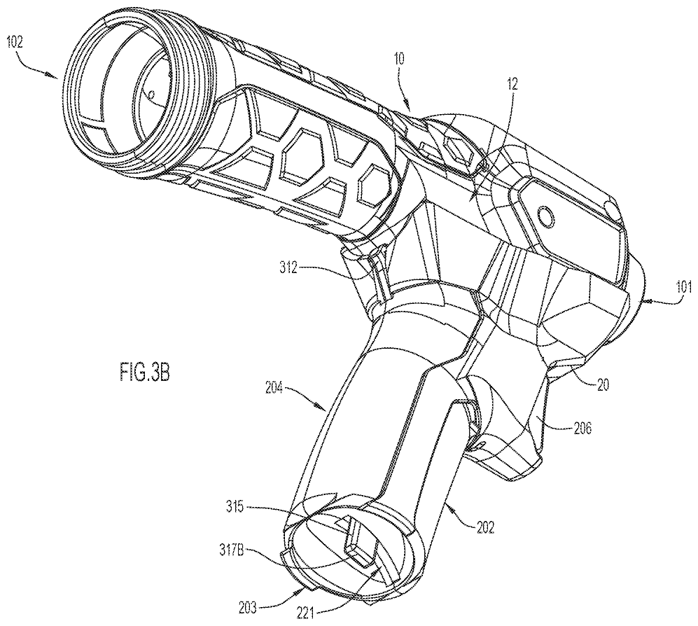

Now referring to FIGS. 3A and 3B, a locking mechanism 310 according to a second embodiment is described. The torch 10 and pistol grip 20 in FIGS. 3A and 3B are substantially the same as those shown in FIGS. 1-2C. For clarity, reference numbers are carried over from the previously described embodiment and refer to substantially the same structures having substantially the same functions. Therefore, only differences between the locking mechanisms 210 and 310 and elements of the pistol grip 20 to accommodate those differences will be discussed. Additionally, the torch head 11, the strain relief 32, and the cable 30 have been omitted in FIGS. 3A and 3B for illustrative purposes only. In FIG. 3A, the locking mechanism 310 is illustrated in both a locked position 310A (solid lines) and unlocked position 310B (dashed lines).

As illustrated in FIGS. 3A and 3B, the pistol grip 20 couples to the torch 10 via the coupling mechanism 17 (e.g., the coupling groove 207 and the coupling protrusion 107) and the locking mechanism 310. The locking mechanism 310 also locks the pistol grip 20 to the torch 10 when in a locked position 310A. That is, the locking mechanism 310 cooperates with the coupling mechanism 17 to attach the pistol grip 20 to the torch 10. The locking mechanism 310 releases the torch body 12 when in an unlocked position 310B, and thus, allows the pistol grip 20 to be removed from the torch 10.

The locking mechanism 310 includes a locking tab, or actuator 312, an actuator arm 315, a biasing member 316, and an actuator pivot 318. The actuator 312 includes an inner surface 313 and a locking protrusion 314 extending from the inner surface 313. When the locking mechanism 310 is in the locked position 310A, the locking protrusion 314 is configured to engage the locking slot 18 in the torch body 12. The actuator 312 is pivotably mounted to the main body 200 via the actuator pivot 318.

In the embodiment depicted in FIGS. 3A and 3B, the locking actuator 312 is a generally narrow tab that is substantially flush with the rear portion 204 of the main body 200 of the pistol grip 20 when in the locked position 310A. In the unlocked position 310B, the actuator 312 protrudes from a slot in the rear portion 204 of the main body 200. The actuator 312 is actuated between the locked position 310A and unlocked position 310B by the actuator arm 315.

The actuator arm 315 includes a proximal end 317A and a distal end 317B. The proximal end 317A is fixed to the actuator pivot 318 of the actuator 312. The actuator arm 315 extends from the pivot 318 toward the distal end 203 of the pistol grip 20 where the distal end 317B protrudes through a distal slot 221 in the main body 200.

The actuator arm 315 is configured to rotate, translate, or otherwise move between a locked position 315A and an unlocked position 315B that correspond to the locked position 310A and unlocked position 310B, respectively, of the locking mechanism 310. That is, the actuator arm 315 is configured to move the actuator 312 between the locked position 310A and the unlocked position 310B. Said another way, to move the actuator 312 to the locked position 310A, a user moves the actuator arm 315 to the locked position 315A. And to move the actuator 312 to the unlocked position 310B, the user moves the actuator arm 315 to the unlocked position 315B. Accordingly, a user can rotate, translate, and/or otherwise move the distal end 317B of the actuator arm 315 protruding through the distal slot 221 to place the actuator 312 in the locked position 310A or the unlocked position 310B. Therefore, the actuator arm 315 can lock or unlock the locking mechanism 310.

As depicted in FIG. 3A, the biasing member 316 is fixed to the interior of the main body 200 and biases the locking mechanism 310 toward the locked position 310A. The biasing member 316 is a spring or other resilient member that is compressible between a locked position 316A and an unlocked position 316B that correspond to locked positions 310A, 315A and unlocked position 310B, 315B of the locking mechanism 310 and actuator arm 315, respectively. The biasing member 316 applies a biasing force to the actuator arm 315 to bias the actuator arm 315 toward the locked position 315A. The biasing force is transmitted through the actuator arm 315 through the pivot 318 to the actuator 312. Consequently, the biasing member 316 biases the actuator 312 toward the locked position 310A. In some implementations, the biasing member 316 may be a leaf spring, a coil spring, or other resilient member fixed to the main body 200 and configured to apply a biasing force to the actuator arm 315.

In the locked position 310A, the locking mechanism 310 cooperates with the coupling mechanism 17 to couple and lock the pistol grip 20 to the torch 10. For example, the locking protrusion 314 engages the locking slot 18 of the torch body 12. The biasing force from the biasing member 316 may be transmitted through the actuator 312 and the locking protrusion 314 to the torch 10 via the locking slot 18, thereby pulling the main body 200 toward the rear portion 204 and up toward the torch body 12 until distal ends of the coupling grooves 207 engage the coupling protrusions 107. That is, the locking mechanism 310 biases the pistol grip 20 into engagement with the torch 10. The locking protrusion 314 and the locking slot 18 further cooperate to prevent the pistol grip 20 from rotating, translating, repositioning, and/or otherwise moving away from the torch 10 (e.g., toward the distal end 203 of the main body 200).

During operation of the torch assembly 1, the actuator 312 is positioned and configured such that a user's grip of the pistol grip 20 prevents the locking mechanism 310 from moving to the unlocked position 310B. When the user grips the main body 200 to operate the torch 1, at least a portion of the actuator 312 engages with and/or supports a portion the user's hand. That is, the actuator 312 is positioned and configured to receive at least a portion of a force applied by the user's grip and transmit that force to the torch body 12. Thus, the actuator 312 is further biased toward a locked position in response to the main body 200 being gripped by the user's hand. Consequently, the actuator 312 cannot be moved to the unlocked position 310B while the pistol grip 20 is gripped by the user operating the torch system 1. That is, the locking mechanism 310 is positioned or otherwise configured to be inaccessible when the user operates the torch assembly 1 during a welding operation

In the unlocked position 310B, the user can disengage the pistol grip 20 from the torch 10 by clearing the rear portion 204 of the main body 200 of any obstructions (e.g., user's hand) and actuating the actuator arm 315 to unlock the locking mechanism 310. For example, the distal end 317B of the actuator arm 315 is translated, rotated, or otherwise moved from the locked position 315A to the unlocked position 315B with sufficient force to overcome the biasing force of the biasing member 316. In response, the actuator 312 translates, rotates, or otherwise moves from the locked position 310A to the unlocked position 310B. With the locking mechanism 310 in the unlocked position 310B, the main body 200 is free to translate, rotate, and/or otherwise move away from the torch 10 until the coupling protrusions 107 are free from the coupling grooves 207, and the pistol grip 20 disengages the torch 10.

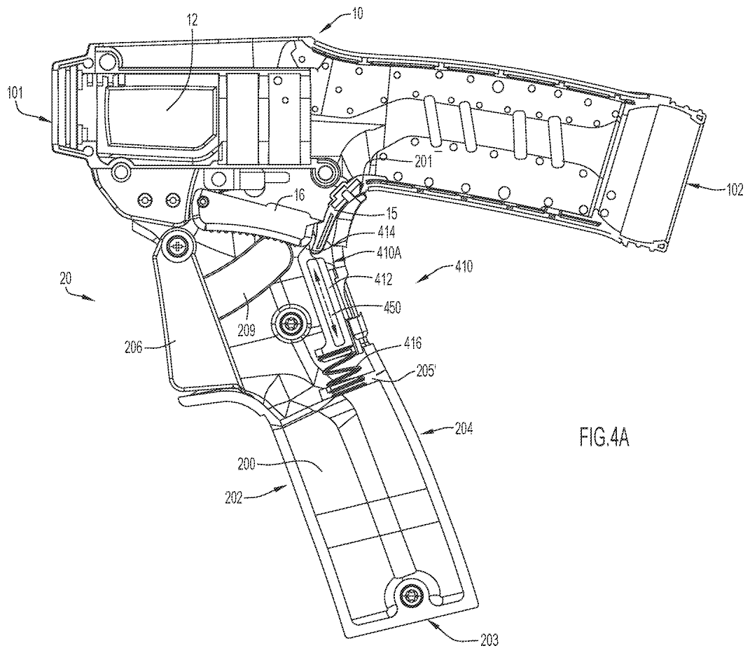

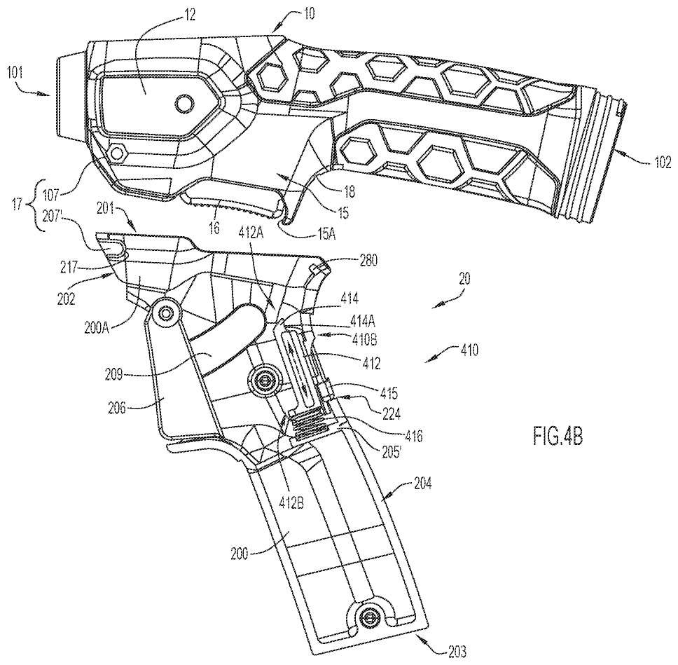

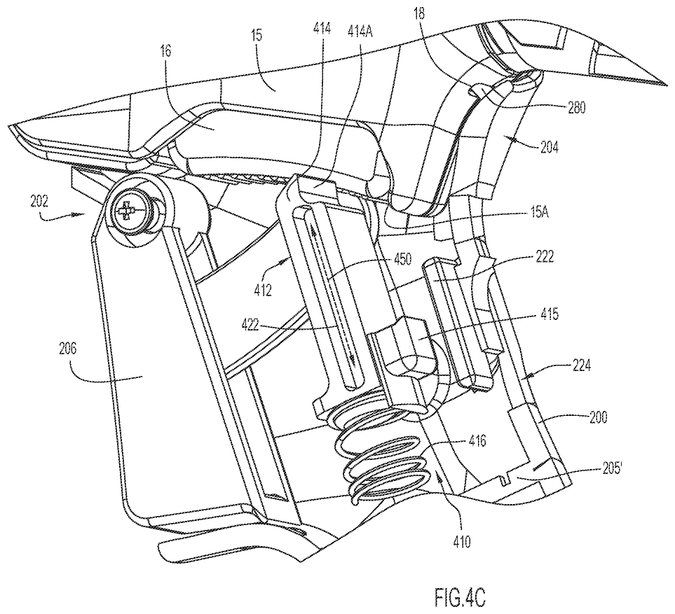

Now referring to FIGS. 4A-4C, a locking mechanism 410 according to a third embodiment is illustrated. The torch 10 and pistol grip 20 in FIGS. 4A-4C are substantially the same as those shown in FIGS. 1-3B. For clarity, reference numbers are carried over from the previously described embodiments and refer to substantially the same structures having substantially the same functions. Therefore, only differences between the locking mechanisms 210, 310, and 410 and elements of the pistol grip 20 to accommodate those differences will be discussed. Additionally, the torch head 11, the strain relief 32, and the cable 30 have been omitted for illustrative purposes only.

In the depicted embodiment, the pistol grip 20 couples to the torch 10 via the coupling mechanism 17. The locking mechanism 410 locks the pistol grip 20 to the torch 10 when in a locked position 410A (shown in FIG. 4A). That is, the locking mechanism 410 cooperates with the coupling mechanism 17 to attach and lock the pistol grip 20 to the torch 10. The locking mechanism 410 releases the torch body 12 when in an unlocked position 410B (shown in FIG. 4B), allowing the pistol grip 20 to be removed from the torch 10.

As best illustrated in FIG. 4B, the coupling mechanism 17 comprises a coupling groove 207′ configured to receive the coupling protrusion 107 of the torch 10. The coupling groove 207′ extends substantially horizontally along the proximal end 201 from the front portion 202 toward the rear portion 204 of the main body 200. A second coupling groove (not shown) is disposed on an opposite interior side of the main body 200 and substantially mirrors the coupling groove 207′. To couple the pistol grip 20 to the torch 10, the coupling grooves 207′ are aligned with the coupling protrusions 107 and the main body 200 translates toward the front end 101 of the torch 10 until the coupling protrusions 107 are fully received in the coupling grooves 207′ and the locking mechanism 410 engages the torch 10. For example, the coupling protrusion 107 contacts a rear wall 217 of the coupling groove 207′ when fully received. Additionally, the main body 200 translates toward the front end 101 of the torch 10 to receive the coupling protrusions 107 and lock the locking mechanism 410. Additionally, or alternatively, the coupling protrusions 107 may be fully received by the grooves 207′ and the main body 200 may then rotate about the protrusions 107 until the locking mechanism 410 engages the torch 10. Regardless of how the main body 200 is moved to engage the torch 10, the coupling mechanism 17 and the locking mechanism 410 cooperate to couple and lock the pistol grip 20 to the torch 10.

In the depicted embodiment, the torch body 12 includes a slot 18 configured to receive a tooth 280 extending from the rear portion 204 along the proximal end 201 of the main body 200 of the pistol grip 20. The slot 18 and the tooth 280 cooperate to reinforce the coupling of the pistol grip 20 to the torch 10. For example, the engagement between the slot 18 and the tooth 280 (in conjunction with the coupling mechanism 17) may prevent the main body 200 from translating, rotating, or otherwise rotating away from the torch 10. However, one or more of these elements may be omitted in some implementations. In some implementations, the tooth 280 may be resilient to reversibly engage and disengage the slot 18.

Still referring to FIGS. 4A-4C, the locking mechanism 410 includes an actuator 412 having a proximal end 412A, a distal end 412B, and a longitudinal axis 450 extending between the proximal end 412A and the distal end 412B. The actuator 412 is configured to translate along the longitudinal axis 450 between the locked position 410A (shown in FIG. 4A) and the unlocked position 410B (shown in FIG. 4B). The actuator 412 further includes an engagement protrusion 414, a biasing member 416, and a guide groove 422. The engagement protrusion 414 extends from the proximal end 412A of the actuator 412 and is configured to engage an inner lip 15A of the trigger housing portion 15 when in the locked position 410A. For example, in the depicted embodiment, the engagement protrusion 414 includes a concave rear face 414A for engaging the inner lip 15A when the locking mechanism 410 is in the locked position 410A. The engagement protrusion 414 bears against the inner lip 15A to prevent the main body 200 from moving toward the rear end 102 of the torch 10 and/or toward the distal end 203 of the main body 200. Consequently, the coupling mechanism 17 cannot be disengaged and the pistol grip 20 and cannot be removed from the torch 10 when the locking mechanism 410 is in the locked position 410A.

The biasing member 416 biases the locking mechanism 410 into the locked position 410A. That is, the biasing member 416 applies a biasing force to the actuator 412 toward the proximal end 201 of the main body 200 (i.e., the locked position 410A). The biasing member is disposed between the distal end 412B of the actuator 412 and a bearing member 205′ extending internally from a sidewall of the main body 200. In the depicted embodiment, the biasing member 416 is a coil spring that bears against the bearing member 205′ and the distal end 412B of the actuator 412 in response to being compressed. Consequently, the actuator 412 is biased toward the locked position 410A by the biasing force from the biasing member 416. In some implementations, the biasing member may be a leaf spring, a torsion spring, and/or an otherwise resilient plate or strip arranged to apply a biasing force to the actuator 412.

As best illustrated in FIG. 4C, the guide groove 422 guides the actuator 412 along a direction parallel to the longitudinal axis 450. The guide groove 422 is disposed in at least one lateral surface of the actuator 412 and extends along a direction parallel to the longitudinal axis 450. The guide groove 422 is configured to receive a corresponding guide rail 222 extending from an inner surface of the main body 200. The guide groove 422 and the guide rail 222 cooperate to guide the actuator 412 along the direction parallel to the longitudinal axis 450 when transitioning between the locked position 410A and the unlocked position 410B. To be clear, the actuator 412 includes guide grooves 422 on two opposing lateral faces. Meanwhile, the inner surface of the main body 200 includes two guide rails 222 corresponding to the guide grooves 422 (the second guide groove and guide rail are not shown).

The guide grooves 422 and guide rails 222 further serve as stops to prevent the actuator 412 from extending beyond the locked position 410A and/or the unlocked position 410B. For example, distal ends of the guide rails 222 serve as stops that engage distal ends of the guide grooves 422 when in the locked position 410A. Meanwhile, proximal ends of the guide rails 222 serve as stops that engage a proximal end of the guide grooves 422 when in the unlocked position 410B. Additionally, the guide grooves 422 and guide rails 222 prevent the actuator 412 from translating in a direction (e.g., perpendicular) that intersects the longitudinal axis 450 (e.g., toward the front portion 202 or rear portion 204 of the main body 200). Accordingly, the guide grooves 422 and guide rails 222 cooperate to guide the actuator 412 between the locked position 410A and the unlocked position 410B. In some implementations, the actuator 412 may include a single guide groove 422 and the main body may have a single guide rail 222 corresponding to the guide groove 422. In some implementations, the guide groove 422 may extend from a first lateral face through to a second lateral face. That is, the guide groove 422 may be a slot that extends through the actuator 412. In some implementations, the actuator 412 may include guide rails and the inner surface of the main body 200 may include guide grooves corresponding to the guide rails.

Still referring to FIGS. 4A-4C, the actuator 412 further incudes a release tab 415 for unlocking the locking mechanism 410. That is, the locking mechanism 410 can be placed into the unlocked position 410B via the release tab 415. The release tab 415 protrudes through a rear slot 224 in the rear portion 204 of the main body 200 near the proximal end 201. A release force that overcomes the biasing force may be applied to the release tab 415. The release force may be applied substantially in a direction parallel to the longitudinal axis 450 to move the actuator 412 into the unlocked position 410B. Thus, the release tab 415 may be utilized to place the locking mechanism 410 into the unlocked position 410B.

The locking mechanism 410 is further positioned and configured to prevent inadvertent release of the torch 10 during operation of the torch system 1. The location of release tab 415 protruding through the main body 200 is generally covered by a user's hand during operation of the torch system 1. That is, the actuator 412 and the release tab 415 are positioned such that the user's hand prevents unlocking the pistol grip 20 from the torch 10 during operation of the torch assembly 1. Consequently, the user's hand covers the release tab 415 and prevents the locking mechanism 410 from translating to the unlocked position 410B. That is, the locking mechanism 410 is positioned or otherwise configured to be inaccessible when a user operates the torch assembly 1 during a welding operation.

Accordingly, a pistol grip for a processing torch, as discussed herein, includes a locking mechanism moveably coupled to a proximal end of a pistol grip and configured to lock the pistol grip to a processing torch. The locking mechanism further prevents unlocking and/or decoupling of the pistol grip during operation of the torch. Moreover, the locking mechanism is configured such that it cannot be moved to an unlocked position when gripped by a user for operation of the processing torch. That is, the locking mechanism is positioned or otherwise configured to be inaccessible when operating the torch assembly 1 during a welding operation.

In some implementations, the mechanical coupling between the pistol trigger 206 and torch trigger 16 (e.g., trigger extension 209) may be replaced with an electrical connection. That is, the pistol grip 20 may be electrically coupled to the torch 10. For example, the pistol trigger 206 may send a control signal indicative of actuation of the pistol trigger 206 to the torch 10 and/or one or more external system components (e.g., a power source, a wire feeder etc.).

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

While the invention has been illustrated and described in detail and with reference to specific embodiments thereof, it is nevertheless not intended to be limited to the details shown, since it will be apparent that various modifications and structural changes may be made therein without departing from the scope of the inventions and within the scope and range of equivalents of the claims. In addition, various features from one of the embodiments may be incorporated into another of the embodiments. Accordingly, it is appropriate that the appended claims be construed broadly and in a manner consistent with the scope of the disclosure as set forth in the following claims.

It is also to be understood that the torch system 1 described herein, or portions thereof, may be fabricated from any suitable material or combination of materials, such as plastic, foamed plastic, metal, supple natural or synthetic materials including, but not limited to, cotton, elastomers, polyester, plastic, rubber, derivatives thereof, and combinations thereof. Suitable plastics may include high-density polyethylene (HDPE), low-density polyethylene (LDPE), polystyrene, acrylonitrile butadiene styrene (ABS), polycarbonate, polyethylene terephthalate (PET), polypropylene, ethylene-vinyl acetate (EVA), or the like. Suitable foamed plastics may include expanded or extruded polystyrene, expanded or extruded polypropylene, EVA foam, derivatives thereof, and combinations thereof.

Reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above,” “below,” “upper,” “lower,” “top,” “bottom,” or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions and/or other characteristics (e.g., time, pressure, temperature, distance, etc.) of an element, operations, conditions, etc., the phrase “between X and Y” represents a range that includes X and Y.

For example, it is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points of reference and do not limit the present invention to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment.

Further, the present disclosure may repeat reference numerals and/or letters in the various examples. This repetition is for the purpose of simplicity and clarity and does not in itself dictate a relationship between the various embodiments and/or configurations discussed.

Similarly, when used herein, the term “comprises” and its derivations (such as “comprising,” etc.) should not be understood in an excluding sense, that is, these terms should not be interpreted as excluding the possibility that what is described and defined may include further elements, steps, etc. Meanwhile, when used herein, the term “approximately” and terms of its family (such as “approximate,” etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about” and “around” and “substantially”.

As used herein, unless expressly stated to the contrary, use of the phrase “at least one of,” “one or more of,” “and/or,” variations thereof, or the like are open-ended expressions that are both conjunctive and disjunctive in operation for any and all possible combination of the associated listed items. For example, each of the expressions “at least one of X, Y and Z,” “at least one of X, Y or Z,” “one or more of X, Y and Z,” “one or more of X, Y or Z” and “X, Y and/or Z” can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms “first,” “second,” “third,” etc., are intended to distinguish the particular nouns they modify (e.g., element, condition, node, outlet, inlet, valve, module, activity, operation, etc.). Unless expressly stated to the contrary, the use of these terms is not intended to indicate any type of order, rank, importance, temporal sequence, or hierarchy of the modified noun. For example, “first X” and “second X” are intended to designate two “X” elements that are not necessarily limited by any order, rank, importance, temporal sequence, or hierarchy of the two elements. Further as referred to herein, “at least one of” and “one or more of” can be represented using the “(s)” nomenclature (e.g., one or more element(s)).

1. A pistol grip for a processing torch comprising:
a main body having a proximal end and a distal end, the proximal end configured to engage a portion of the processing torch;
a pistol trigger having a trigger extension, the pistol trigger pivotably coupled to the main body; and
a locking mechanism movably coupled to the main body adjacent the proximal end of the main body, the locking mechanism being movable between an unlocked position and a locked position where the locking mechanism locks the main body in a fixed position with respect to the processing torch.

2. The pistol grip of claim 1, further comprising a groove disposed in an inner surface of the proximal end of the main body, the groove configured to receive a protrusion extending from the processing torch.

3. The pistol grip of claim 1, wherein the locking mechanism comprises:
a locking tab; and
a biasing member configured to bias the locking tab toward the locked position.

4. The pistol grip of claim 3, further comprising a protrusion extending from an inner surface of the locking tab, wherein the protrusion is configured to engage a slot in the processing torch when the locking mechanism is in the locked position.

5. The pistol grip of claim 3, wherein the locking mechanism is prevented from repositioning from the locked position to the unlocked position when the pistol grip is gripped by a user's hand.

6. The pistol grip of claim 3, wherein the locking mechanism is configured to move to and remain in the locked position when the pistol grip is gripped by a user's hand.

7. The pistol grip of claim 3, wherein the locking mechanism is configured to disengage from the processing torch in response to a release force being applied to the locking tab.

8. The pistol grip of claim 1, wherein the trigger extension is configured to engage a torch trigger included in the processing torch when the pistol trigger is actuated.

9. The pistol grip of claim 1, wherein the locking mechanism cooperates with the main body to define an opening for receiving the portion of the processing torch.

10. A torch comprising:
a torch head;
a body portion; and
a pistol grip removably coupled to the body portion, the pistol grip comprising:
a distal end;
a proximal end configured to engage the body portion; and
a locking mechanism operable between a locked position and an unlocked positioned;
wherein the locking mechanism is prevented from moving to an unlocked position when the pistol grip is gripped by a user's hand.

11. The torch of claim 10, wherein the pistol grip is removably coupled to the body portion via a pin and groove arrangement.

12. The torch of claim 10, wherein the locking mechanism is coupled to the proximal end of the pistol grip.

13. The torch of claim 10, wherein the locking mechanism prevents the pistol grip from decoupling from the body portion when in the locked position.

14. The torch of claim 10, wherein the locking mechanism comprises:
a locking tab; and
a biasing member configured to bias the locking tab toward the locked position.

15. The torch of claim 14, wherein the locking tab comprises a protrusion extending from an inner surface, the protrusion configured to engage a recess disposed in the body portion.

16. The torch of claim 10, wherein the body portion comprises:
a trigger housing portion disposed on a bottom of the body portion, the trigger housing portion configured to receive the pistol grip.

17. A method comprising:
inserting a protrusion extending from a torch into a groove of a pistol grip;
moving the pistol grip in a first direction until a locking mechanism disposed on a proximal end of the pistol grip engages the torch; and
biasing the locking mechanism into a locked position to lock the pistol grip to the torch.

18. The method of claim 17, further comprising:
moving a locking tab of the locking mechanism from the locked position to an unlocked position.

19. The method of claim 18, further comprising:
rotating the pistol grip in a second direction, opposite the first direction to disengage the pistol grip from the torch.

20. The method of claim 19, further comprising:
removing the protrusion from the groove to decouple the torch and the pistol grip.
